(19) United States
(12) Patent Application Publication
(10) Pub. No.: US 2004/0153666 A1
(43) Pub. Date: Aug. 5, 2004

(54) Structured rollout of updates to malicious computer code detection definitions

(76) Inventor: William E. Sobel, Stevenson Ranch, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/359,416

(22) Filed: Feb. 5, 2003

(51) Int. Cl. G06F 11/30; G06F 15/173

(52) U.S. Cl. 713/201; 709/224

(57) ABSTRACT

Methods, systems, and computer-readable media for updating a module (305) for detecting attacking agents. In one embodiment, a scanning engine module (305) determines a risk rating for a client computer system (105). The client (105) determines a request time based upon the risk rating and transmits a request for an update of the scanning engine module (305) to an update server (100) at the request time. The update server (100) then transmits to the client (105) an update for the scanning engine module (305).

### TECHNICAL FIELD

This invention relates generally to enhancing the performance of malicious code detection methods in computers. Specifically, this invention relates to scheduling updates to computer virus detection modules.

### BACKGROUND ART

During the brief history of computers, system administrators and users have been plagued by attacking agents such as viruses, worms, and Trojan Horses, which are designed to disable host computer systems and/or propagate themselves to connected systems.

In recent years, two developments have increased the threat posed by these attacking agents. Firstly, increased dependence on computers to perform mission critical business tasks has increased the economic cost associated with system downtime. Secondly, increased interconnectivity among computers has made it possible for attacking agents to spread to a large number of systems in a very short period of time.

While anti-virus programs are able to detect and remove attacking agents, new attacking agents that are designed to work around existing programs are constantly being produced. Thus, it is important to frequently update these anti-virus programs to detect newly released attacking agents. Often, these updates are produced in response to a specific attacking agent outbreak.

These updates are typically provided by vendors of the anti-virus programs. The vendors make updates available and the clients schedule windows in which to retrieve the updates. While the specific times for these updates are typically selected at random, during the broad update windows, it may be useful to provide expedited updates to client machines of particular importance. What is needed is a method of determining a schedule of updates for clients in response to the importance of each client system.

### DISCLOSURE OF INVENTION

The present invention relates to methods, systems, and computer-readable media for updating a scanning engine module (305) that detects attacking agents. In one embodiment the scanning engine module (305) determines a risk rating for a client computer system (105). The client (105) determines a request time based upon the risk rating and transmits a request for an update of the scanning engine module (305) to an update server (100) at the request time. The update server (100) then transmits to the client (105) an update for the scanning engine module (305).

### BRIEF DESCRIPTION OF THE DRAWINGS

These and other more detailed and specific objects and features of the present invention are more fully disclosed in the following specification, reference being had to the accompanying drawings, in which:

FIG. 1 is a high level block diagram illustrating interaction among a server 100 and two clients 105.

FIG. 2 is a high level block diagram illustrating a more detailed view of a client computer system 105.

FIG. 3 is a more detailed view of a memory 206 and storage 208 of the client computer system 105.

FIG. 4 is a block diagram illustrating a closer view of a scanning engine module 305.

FIG. 5 is a flow chart illustrating an embodiment of the invention in which the client 105(1) pulls an update from the server 100.

FIG. 6 is a flow chart illustrating an embodiment of the invention in which the server 100 pushes an update to the client 105(1).

### DETAILED DESCRIPTION OF THE PREFERRED EMBODIMENTS

The present invention determines an update priority for scanning engine modules 305 that detect malicious code on computer systems 105, 110. As used herein, the term “malicious code” refers to any program, module, or piece of code that enters a computer without an authorized user's knowledge and/or without an authorized user's consent. The term “attacking agent” includes Trojan Horse programs, worms, viruses, and other such insidious software that insert malicious code into a computer. An attacking agent may include the ability to replicate itself and compromise other computer systems.

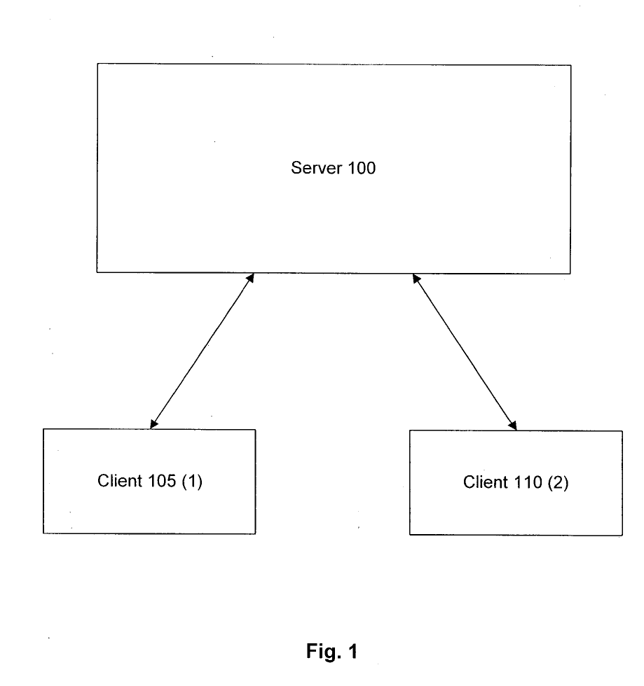

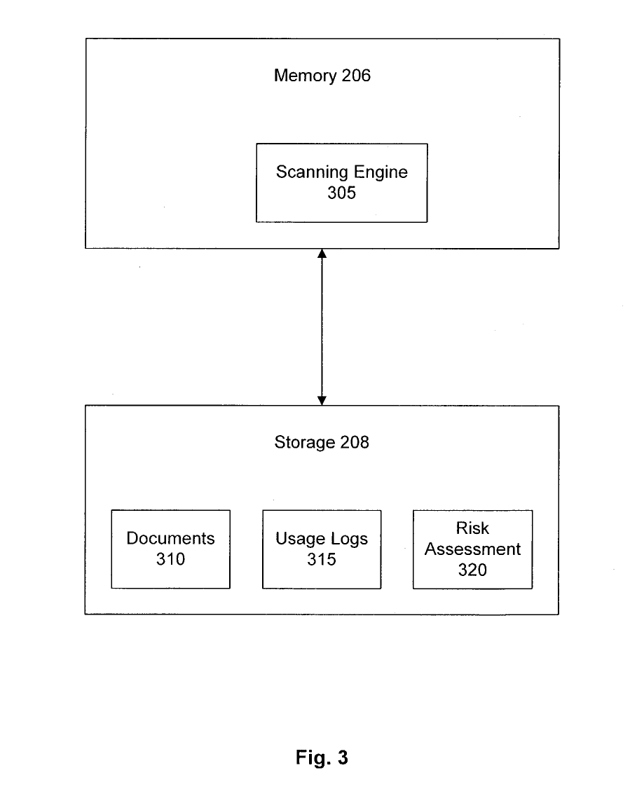

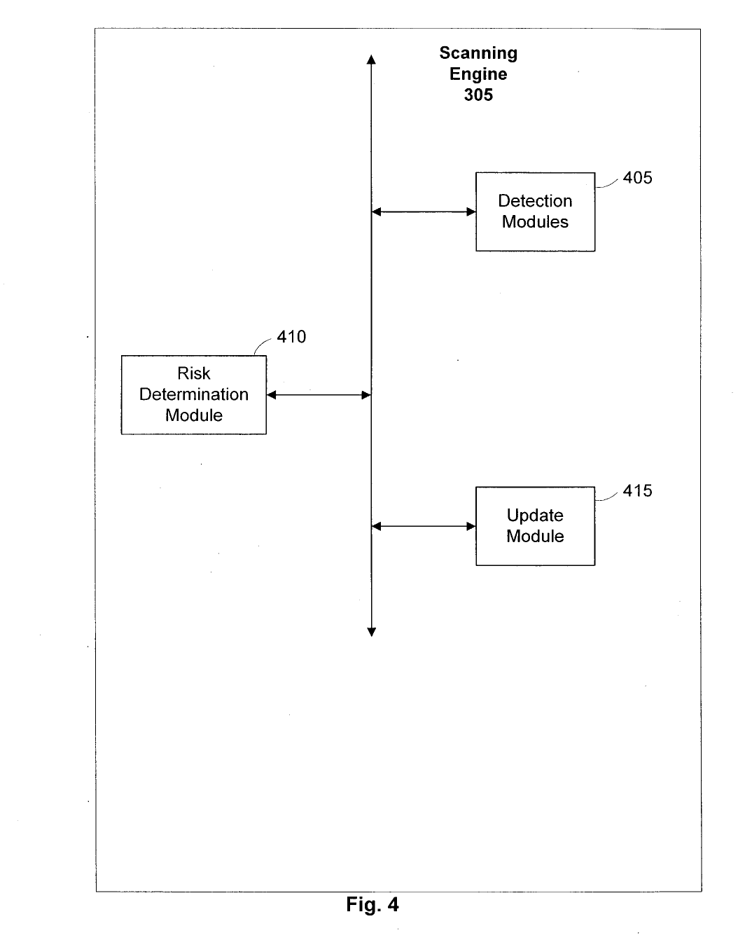

FIG. 1 is a high level block diagram illustrating interaction among a server 100 computer and two client computers 105. The clients 105 are end user systems that are used for conventional computing tasks. Each client includes a scanning engine module 305. The scanning engine 305 module is responsible for detecting and eliminating attacking agents and is described in greater detail with respect to FIGS. 3 and 4.

The server 100 is maintained by a vendor of anti-virus software or by another interested party (corporation, ISP, etc.) running software provided by the vendor and has a group of clients 105 which it services. Periodically, the clients 105 obtain updates to the scanning engine module from the server 100. These updates may be obtained as part of routine maintenance or in response to a particular attacking agent outbreak. The clients 105 may interact with the server 100 through a private Local Area Network (LAN) or Wide Area Network (WAN), or through the Internet.

In one embodiment, the clients 105 receive updates through a pull system. Each client 105 determines a risk rating and schedules a contact time according to said client's risk rating. At a predetermined time, each client 105 contacts the server 100 and requests an update. The server 100 transmits the update to the client 105, which then updates the scanning engine module.

In an alternate embodiment, the server 100, provides updates through a push system. The clients 105 each determine a risk rating. The server 100 polls all of the clients 105 for which it is responsible to and receives the risk rating for each client 105. The server 100 then schedules updates for each client 105 according to said client's risk rating. At the scheduled time, the server 100 transmits updates to the clients 105.

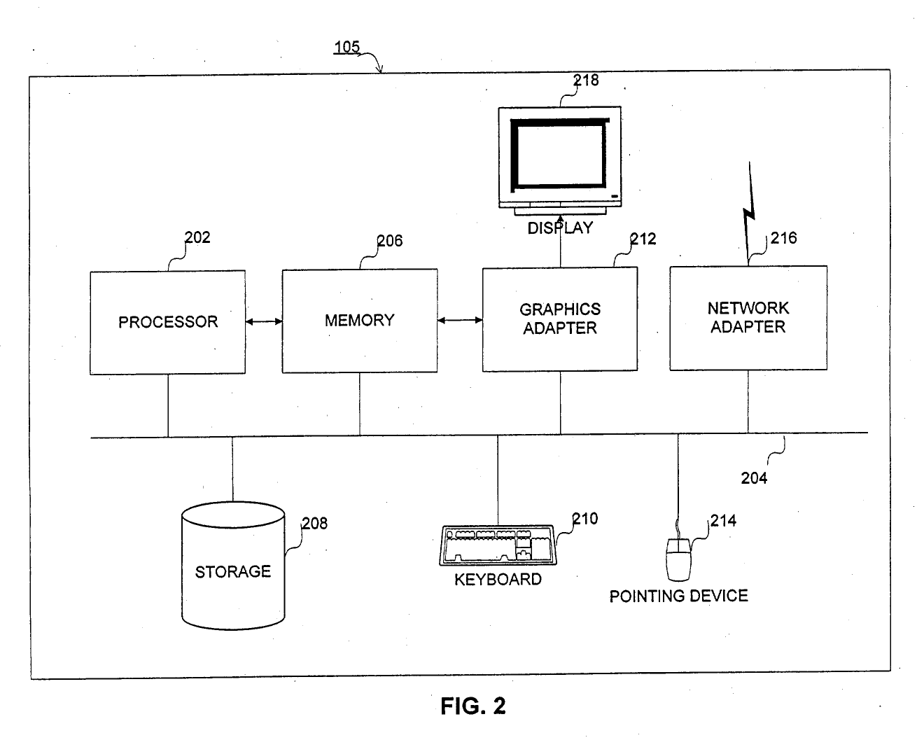

FIG. 2 is a high level block diagram illustrating a client computer system 105. Illustrated are a processor 202 coupled to a bus 204. There may be more than one processor 202. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any specific or general-purpose processor such as an INTEL x86 or POWERPC-compatible central processing unit (CPU). The storage device 208 may be any device capable of holding large amounts of data, such as a hard drive, compact disk read-only memory (CD-ROM), DVD, or some other form of fixed or removable storage device.

FIG. 3 is a more detailed view of a memory 206 and storage 208 of the client computer system 105. The scanning engine module 305 identifies data to be checked for the presence of attacking agents, checks for the attacking agents, and, if necessary, responds to a detected attacking agent. While in the present embodiment, the scanning engine module resides in the memory 206, in alternate embodiments, some or all of the scanning module 305 resides in the storage 208. The scanning engine module 305 identifies particular files and/or memory locations to be checked for attacking agents. Other data that may be identified by the scanning engine module 305 includes emails received or sent by the client 105(1), streaming data received from the Internet, etc. The scanning engine module 305 includes a number of virus definitions, each definition associated with the detection of a particular attacking agent or particular group of attacking agents. The scanning engine module 305 also includes a group of broader detection heuristics which can be used to detect attacking agents for which specific definitions have not yet been developed. Periodically, the definitions and heuristics are updated to include additional attacking agents or to improve the detection of attacking agents that are already associated with existing definitions.

The scanning engine module 305 maintains a risk assessment 320 on the storage 208. The risk assessment 320 indicates the importance of the client computer 105, and the degree of damage that is associated with an infection of the client system 105. The scanning engine module 305 maintains usage logs 315, indicating the amount and frequency and type of activity by a user of the client system 105. The usage logs 315 indicate the frequency at which files are created, which applications are run on the client system, and the number of incoming and outgoing network communications such as emails.

The scanning engine module 305 checks the number of documents 310 on the client 105(1), and the usage logs 315 in determining the risk assessment 320, with a larger number of files 310 and a higher amount of activity indicating a greater degree of risk. The scanning engine module 305 is also configured to determine the identities of users of the client 105(1), and to apply these identities when determining the risk assessment 320. In one embodiment, a system administrator stores a list of users and their corresponding degrees of importance on the client 105(1), and the scanning engine module 305 uses the importance of a user of the client 105, to generate the risk assessment 320. As used herein, the “importance” of a user can indicate both the likelihood that this user's computer will be attacked as well as the potential damage that would ensue from such an attack.

In one embodiment, the scanning engine module 305 updates the risk assessment 320 in response to a request from a server 100. In an alternate embodiment, the scanning engine module 305 updates the risk assessment 320 as part of a regular maintenance routine.

FIG. 4 is a block diagram illustrating a closer view of a scanning engine module 305. The scanning engine module 305 includes a plurality of detection modules 405. The detection modules 405 are configured to check files or file fragments in memory 206 or storage 208 for the presence of malicious code. The detection modules 405 typically check selected areas of a file for distinct code sequences or other signature information. Alternately, the detection modules 405 may check the file for distinctive characteristics such as a particular size.

The detection modules 405 can additionally apply more complex detection techniques to a file. For example, the detection modules 405 can detect the presence of a polymorphic encrypted virus. A polymorphic encrypted virus (“polymorphic virus”) includes a decryption routine and an encrypted viral body. To avoid standard detection techniques, polymorphic viruses use decryption routines that are functionally the same for each infected file, but have different sequences of instructions. To detect these viruses, the detection modules 405 apply an algorithm that loads the executable file into a software-based CPU emulator acting as a simulated virtual computer. The file is allowed to execute freely within this virtual computer. If the executable file does contain a polymorphic virus, the decryption routine is allowed to decrypt the viral body. The detection modules 405 detect the virus by searching through the virtual memory of the virtual computer for a signature from the decrypted viral body. The detection modules 405 may also be configured to detect metamorphic viruses, that, while not necessarily encrypted, also vary the instructions stored in the viral body.

The scanning engine module 305 additionally includes a risk determination module 410. The risk determination module 410 is configured to generate a risk assessment 320 in response to the state of the client system 105. The risk determination module checks the number of documents 310 on the client 105(1), and the usage logs 315 in determining the risk assessment 320. The risk determination module 410 additionally determines an identity of a user of the client 105(1) and applies the identity when determining the risk assessment 320.

The scanning engine module 305 also includes an update module 415. The update module 415 is configured to determine the necessity of an update for the scanning engine module 305. In one embodiment, the update module periodically contacts the server 100 as part of routine maintenance. In an alternate embodiment, the server 100 contacts the client 105(1) when new definitions are available. The update module 415 receives the new definitions from the server 100 and updates the detection modules 405 accordingly.

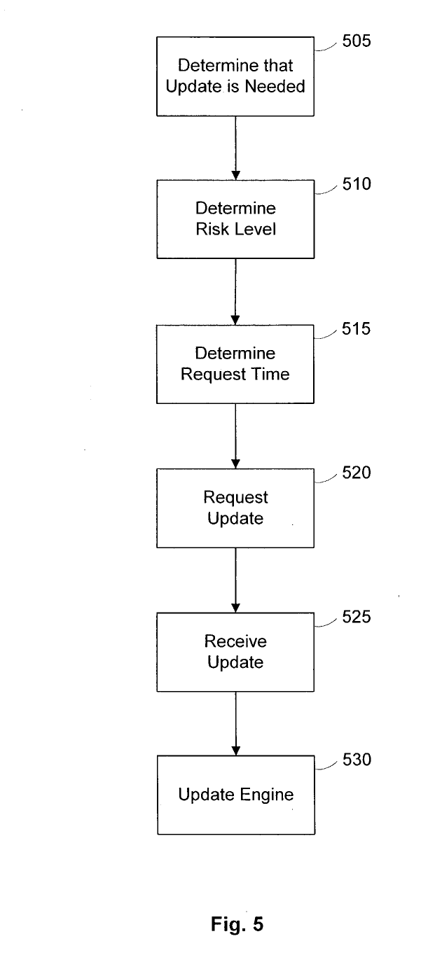

FIG. 5 is a flow chart illustrating an embodiment of the invention in which the client 105(1) pulls an update from the server 100. The process begins with the update module 415 determining 505 that an update to the scanning engine module 305 is needed. In one embodiment, the client 105(1) periodically contacts the server 100 to determine if updates to the scanning engine module 305 are available. The scanning engine module 305 typically includes a version number. The client 105(1) obtains the version number of the newest version of the scanning engine module 305 that is available, and if the version is newer than the current version of the scanning engine module 305 residing on the client 105(1) determines that an update is needed.

The risk determination module 410 then determines 510 a risk level for the client 105(1). In one embodiment, the risk determination module 410 generates a new risk assessment 320. In an alternate embodiment, the risk determination module 410 uses the risk level indicated in the current risk assessment 320.

The update module 415 then determines 515 a request time in response to the determined risk level. In one embodiment, all clients 105 associated with a particular server 100 have a particular time window during which they may receive updates such as 12 am (midnight) to 2 am. The update module 415 schedules the update time within the window according to the level of risk, with a higher degree of risk indicating an earlier update time. Referring to the example above, if the risk assessment 320 indicated a high degree of risk, the update module 415 schedules the update at 12:15. In an alternate embodiment, the client 105 skips step 515 and immediately requests the update. In this embodiment, the client transmits the risk assessment 320 to the server 100 upon requesting 520 the update.

The update module 415 then transmits 520 an update request to the server 100. If the server 100 does not have sufficient capacity to update the client at the time, the server 100 can reschedule the update or queue its request.

When the server 100 has sufficient resources to transmit the update, the client 105(1) receives 525 the update from the server 100. In one embodiment, the server 100 transmits a series of modules, that, when executed, replace the virus definitions in the scanning engine module 305, with newer definitions.

The update module 415 then executes the downloaded modules to update 530 the scanning engine module 305. The update process replaces those detection modules 405 for which new definitions are available, and adds additional detection modules 405 for any new attacking agents that the new version of the scanning engine module 305 is configured to detect.

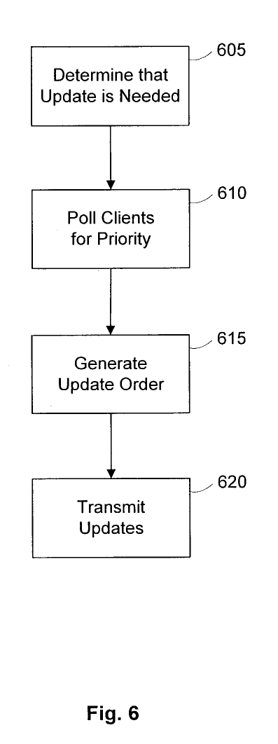

FIG. 6 is a flow chart illustrating an embodiment of the invention in which the server 100 pushes an update to the client 105(1). The server first determines 605 that an update is needed. This determination is typically made when the vendor generates updated virus definitions for the scanning engine module 305.

The server 100 polls 610 all of the clients 105 for which it is responsible to determine update priorities for each of the clients 105. The server 100 queries each of the clients 105 for their risk levels. The clients 105 generate risk ratings and transmit the risk ratings to the server 100.

The server 100 then generates 615 an update order for the clients 105, the update order indicating a succession of clients to be updated. The update order is preferably sequenced according to the risk level of each of the clients 105, with higher risk clients updated first. The server 100 then transmits 620 the updates to the clients according to the generated order.

In an alternate embodiment, steps 610 and 615 are performed as part of a routine maintenance of the clients 105. When an attacking agent outbreak occurs, the server 100 transmits 620 the updates according to the existing update order.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A method for updating an attacking agent detection module in a computer system, the method comprising the steps of:
determining a risk rating for the computer system;
determining a request time in response to the determination of the risk rating;
transmitting a request for an update of the module to an update server at the request time; and
receiving the update from the update server.

2. The method of claim 1, wherein the step of determining a risk level comprises the sub-step of determining an identity of a user of the computer system.

3. The method of claim 1, wherein the step of determining a risk level comprises determining a number of files on the computer system.

4. The method of claim 1, wherein the step of determining a risk level comprises determining a level of activity for the computer system.

5. The method of claim 4, wherein the level of activity comprises a number of files modified in a predetermined period of time.

6. The method of claim 4, wherein the level of activity comprises an amount of network communication.

7. The method of claim 4, wherein the level of activity comprises an indicator of which applications are run on the client system.

8. The method of claim 1, further comprising the step of contacting the server to determine whether a newer version of the module is available.

9. A method for transmitting updates to an attacking agent detection module to a plurality of client computer systems, the method comprising the steps of:
requesting a risk rating from each of the plurality of client computer systems;
receiving a risk rating from each of the plurality of client computer systems;
generating an update order for the client computer systems in response to the risk ratings; and
transmitting updates to the client computer systems according to the update order.

10. The method of claim 9, wherein the step of determining a risk rating for a client computer system is determined in part according to an identity of a user of the client computer system.

11. The method of claim 9, wherein the risk rating for a client computer system is determined in part according to a number of files on the client computer system.

12. The method of claim 9, wherein the risk rating for a client computer system is determined in part according to a level of activity on the client computer system.

13. A system for updating a scanning engine module in a computer system, the system comprising:
a risk determination module, configured to generate a risk assessment for the computer system;
an update module, coupled to the risk determination module, and configured to:
determine a request time in response to the risk assessment;
transmit a request for an update of the scanning engine module to an update server at the request time; and
receive the update from the update server.

14. The system of claim 13, wherein the risk determination module generates the risk assessment in response to an identity of a user of the computer system.

15. The system of claim 13, wherein the risk determination module generates the risk assessment in response to a number of files on the computer system.

16. The system of claim 13, wherein the risk determination module generates the risk assessment in response to an activity level of the computer system.

17. A computer-readable medium containing computer code instructions for updating an attacking agent detection module in a computer system, the computer code comprising instructions for:
determining a risk rating for the computer system;
determining a request time in response to the determination of the risk rating;
transmitting a request for an update of the module to an update server at the request time; and
receiving the update from the update server.

18. The computer-readable medium of claim 17, wherein the instructions for determining a risk level comprise instructions for determining an identity of a user of the computer system.

19. The computer-readable medium of claim 17, wherein the instructions for determining a risk level comprise instructions for determining a number of files on the computer system.

20. The computer-readable medium of claim 17, wherein the instructions for determining a risk level comprise instructions for determining a level of activity for the computer system.

21. The computer-readable medium of claim 17, further comprising instructions for contacting the server to determine whether a newer version of the module is available.

22. A computer-readable medium containing computer code instructions for transmitting updates to an attacking agent detection module to a plurality of client computer systems, the computer code comprising instructions for:
requesting a risk rating from each of the plurality of client computer systems;
receiving a risk rating from each of the plurality of client computer systems;
generating an update order for the client computer systems in response to the risk ratings; and
transmitting updates to the client computer systems according to the update order.

23. The computer-readable medium of claim 22, wherein the risk rating for a client computer system is determined in part according to an identity of a user of the client computer system.

24. The computer-readable medium of claim 22, wherein the risk rating for a client computer system is determined in part according to a number of files on the client computer system.

25. The computer-readable medium of claim 22, wherein the risk rating for a client computer system is determined in part according to a level of activity on the client computer system.

26. A method for updating an attacking agent detection module in a computer system, the method comprising the steps of:
determining a risk rating for the computer system;
transmitting the risk rating and a request for an update of the module to an update server at the request time; and
receiving the update from the update server.
